(19) United States
(12) Patent Application Publication
(10) Pub. No.: US 2009/0189927 A1
(43) Pub. Date: Jul. 30, 2009

(54) Tachograph for a Motor Vehicle

(75) Inventors: Klaus Hug, Oberndorf (DE); Herbert Kirner, Villingen-Schwenningen (DE); Benjamin Säger, Villingen-Schwenningen (DE); Harald Trampert, Villingen-Schwenningen (DE); Torsten Wahler, Bad Dürrheim (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/227,992

(22) PCT Filed: May 31, 2007
(86) PCT No.: PCT/EP2007/055282

§ 371 Date: Dec. 4, 2008

(30) Foreign Application Priority Data
Jun. 8, 2006 (DE) 102006026706.0

(51) Int. Cl. G01P 1/12

(52) U.S. Cl. 346/33 D

(57) ABSTRACT

In a tachograph for a motor vehicle having a holder for a paper strip, which is wound onto a paper roll, and a printing unit, means for prestressing the paper strip against a stop are provided. This reliably keeps the paper strip in an envisaged position with respect to the printing unit. A printout produced by the printing unit is thus oriented on the paper strip with respect to a zero line.

The invention relates to a tachograph for a motor vehicle, with a receptacle for a paper strip wound on a paper roll, with a printing unit for the output of data in exactly intended positions with respect to a zero line of a region to be printed, said zero line extending longitudinally over the paper strip in the intended direction of movement, and with a drive device for driving the paper strip.

Known tachographs, as a rule, have a spiked roller, the spikes of which penetrate into marginal perforations of the paper strip and ensure the advance of the paper strip under the printing unit. The marginal perforation of the paper strip serves for orienting the printing unit with respect to the region to be printed, on which, as a rule, a grid having the zero line is arranged. When a new paper roll is inserted, the printing unit is set into a reference position with respect to the region to be printed. Setting is intended to ensure that the data, for example a graphical representation of the driving speed of the motor vehicle against time are transferred to the grid in the intended positions.

The known tachograph has the disadvantage, however, that tolerances between the printing unit and the visible grid of the paper roll region to be printed may occur, and therefore the position of the data with respect to the visible grid is not reliably ensured. Such tolerances may arise, for example, due to a skewing of the spiked roller. Furthermore, the marginal perforations require a very wide paper strip which can be printed on only in a narrow region.

The problem on which the invention is based is to develop a tachograph of the type initially mentioned, such that it allows a particularly reliable assignment of the data output from the printing unit in relation to the zero line on the paper strip and avoids marginal perforations on the paper strip.

This problem is solved, according to the invention, by means of a stop laterally supporting the paper strip in an intended position with respect to the printing unit and by means for prestressing the paper strip against the stop.

This configuration ensures that the paper strip is held reliably at the stop. Since the printing unit and the stop are arranged in the tachograph and the position of the zero line with respect to the lateral boundary of the paper strip is known, the printing unit can be oriented particularly reliably with respect to the zero line and consequently to the region to be printed. After the insertion of the paper roll into the tachograph, after a sample print-out and determination of a possible tolerance-related error in the sample print-out, the error can be compensated in a simple way by means of a mechanical correction of the stop or of the printing unit. An electronic correction of the tolerance-related error is, of course, also possible by means of a corresponding activation of the printing unit. Since, by virtue of the invention, the paper strip is oriented at the stop, there is no need for a marginal perforation.

According to an advantageous development of the invention, a reliable orientation of the output data with respect to the zero line can be achieved in a simple way if the stop is arranged in a paper guide guiding the paper strip under the printing unit.

According to another advantageous development of the invention, the paper roll is automatically oriented during insertion if the stop is arranged on a reception gudgeon holding the paper roll. For this purpose, preferably, the reception gudgeon is of multipart design and has a movable disk for supporting the spring element. The paper roll is then tension-mounted between the disk and the stop.

The tachograph according to the invention has a particularly simple structural configuration if the stop is arranged on one side of a printer drawer receiving the paper roll.

In particular, moisture influences may lead to a swelling or shrinking of the width of the paper strip and consequently may impair the accuracy of the output of the data with respect to the zero line. According to another advantageous development of the invention, an influence of a swelling or shrinking of the paper strip on the accuracy of the output of the data with respect to the zero line can be kept particularly low if the stop is arranged at that lateral boundary of the paper strip which comes nearest to the zero line.

According to another advantageous development of the invention, a reliable orientation of the paper roll in the tachograph and therefore also with respect to the printing unit can be ensured in a simple way if the means for prestressing the paper strip have a spring element prestressing the paper roll against the stop.

According to another advantageous development of the invention, a continuous guidance of the paper strip against the stop can be ensured in a simple way if the means for prestressing the paper strip have a drive roller and a mating roller standing opposite the drive roller and intended for prestressing the paper strip against the drive roller, the drive roller and/or the mating roller being of conical configuration. Preferably, the mating roller is prestressed elastically against the drive roller. Owing to the conical configuration of the mating roller or of the drive roller, different circumferential speeds can be generated which guide the paper strip toward the small-diameter side of the mating roller or of the drive roller. On the small-diameter side of the mating roller or of the drive roller, the stop limits the further movement of the paper strip and guides the latter to the printing unit.

The invention permits numerous embodiments. To make its basic principle even clearer, one of these is illustrated in the drawing and is described below. In the drawing:

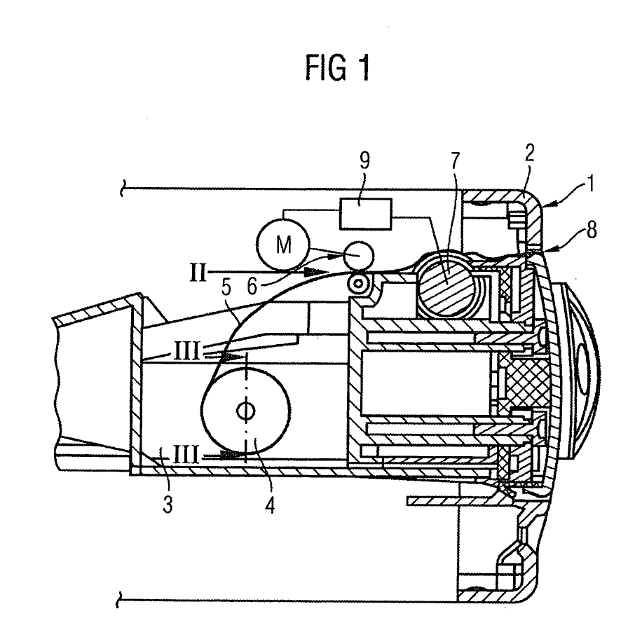

FIG. 1 shows a longitudinal section through a tachograph according to the invention,

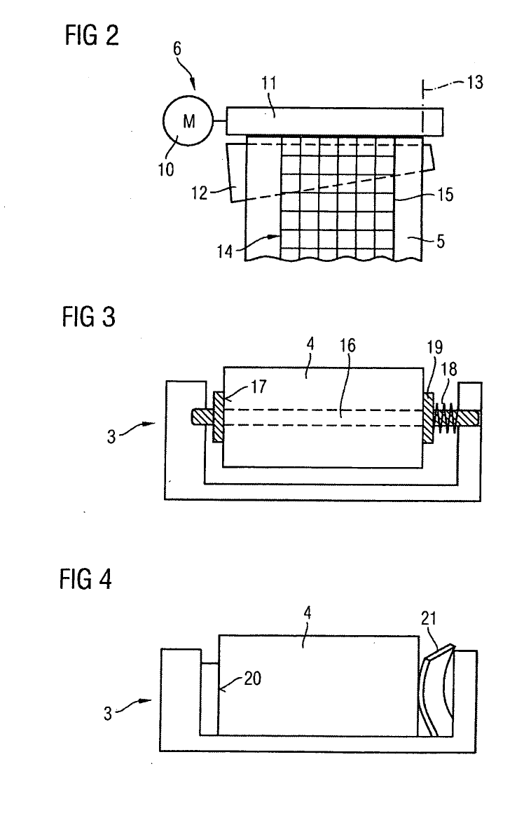

FIG. 2 shows, enlarged, a drive device for a paper strip of the tachograph from FIG. 1, from position II,

FIG. 3 shows, enlarged, a sectional illustration through a printer drawer of the tachograph from FIG. 1, along the line III-III,

FIG. 4 shows, enlarged, a sectional illustration through a further embodiment of the printer drawer from FIG. 1.

FIG. 1 shows a tachograph 1 for a motor vehicle in longitudinal section, with a front cover 2 and with a printer drawer 3 for receiving a paper roll 4. A paper strip 5 is wound on the paper roll 4 and is transported by means of a drive device 6 to a printing unit 7 and from there to a gap 8 in the front cover 2. The printing unit 7 and the drive device 6 are connected to an electronic control unit 9. Through the gap 8 in the front cover 2, the paper strip 5 printed by the printing unit 7 is output and can be torn off. Furthermore, the electronic control unit 9 may be provided with sensors, not illustrated, which sense markings, likewise not illustrated, on the paper strip 5.

FIG. 2 shows the drive device 6 from FIG. 1, from position II. It can be seen, here, that the drive device 6 has a drive roller 11 driven by an electric motor 10 and a mating roller 12 standing opposite said drive roller. The mating roller 12 is prestressed elastically against the drive roller 11 and is of conical configuration. The paper strip 5 is tension-mounted between the mating roller 12 and the drive roller 11. A stop 13, illustrated diagrammatically in the drawing behind the mating roller 12 and the drive roller 11 in the drawing plane, is arranged on the small-diameter side of the conical mating roller 12. When the drive roller 11 is driven, the mating roller 12 is moved and draws the paper strip 5 toward the small-diameter side of the conical mating roller 12. Since the stop 13 is arranged on this side, the drive roller 11, together with the conical configuration of the mating roller 12, forms means for prestressing the paper strip 5 against the stop 13. These means ensure that the paper strip 5 is fed in an intended orientation to the printing unit 7 from FIG. 1. A grid 14 for a region to be printed is arranged on the paper strip 5. The region to be printed is delimited by a zero line 15. The zero line 15 is arranged near to the side of the stop 13 in the tachograph 1.

FIG. 3 shows a sectional illustration through the printer drawer 3 of the tachograph 1 from FIG. 1, along the line III-III, together with the paper roll 4. The paper roll 4 is arranged on a reception gudgeon 16 mounted in the printer drawer 3. The reception gudgeon 16 has a stop 17 for supporting the paper roll 4 and has an axially displaceable disk 19 prestressed by a spring element 18. The spring element 18 prestresses the disk 19 and consequently the paper roll 4 in the direction of the stop 17. The disk 19 and the spring element 18 consequently form means for prestressing the paper strip 5, wound on the paper roll 4, against the stop 17.

FIG. 4 shows a further embodiment of the printer drawer 3 of the tachograph 1, in which one side of the printer drawer 3 has a stop 20 for the paper roll 4. A spring element 21 supported on the opposite side of the printer drawer 3 prestresses the paper roll 4 against the stop 20. The spring element 21 and the printer drawer 3 consequently form means for prestressing the paper strip 5, wound on the paper roll 4, against the stop 20.

1.-7. (canceled)

8. A tachograph for a motor vehicle, the tachograph comprising:
a receptacle adapted to receive a paper strip wound on a paper roll;
a printing unit for printing data with respect to a zero line of the paper strip, said zero line extending longitudinally over the paper strip in the intended direction of movement;
a drive device for driving the paper strip;
at least one stop laterally supporting the paper strip in an intended position with respect to the printing unit; and
means for prestressing the paper strip against the at least one stop.

9. The tachograph according to claim 8, wherein the at least one stop is a drive roller stop arranged in a paper guide for guiding the paper strip to the printing unit.

10. The tachograph according to claim 8, wherein the at least one stop is arranged on a reception post adapted to hold the paper roll.

11. The tachograph according to claim 8, wherein the at least one stop is arranged on one side of the receptacle adapted to receive the paper roll.

12. The tachograph according to claim 8, wherein the at least one stop is arranged at a lateral boundary of the paper strip nearest to the zero line.

13. The tachograph according to claim 8, wherein the means for prestressing the paper strip is a spring element.

14. The tachograph according to claim 8, wherein the drive device further comprises:
a drive roller; and
a mating roller opposite the drive roller and prestressed against the drive roller,
wherein at least one of the drive roller and the mating roller have a conical configuration and the paper strip is tension-mounted between the drive roller and the mating roller.

15. The tachograph according to claim 14, wherein the at least one stop is arranged on a reception post adapted to hold the paper roll.

16. The tachograph according to claim 15, further comprising a drive roller stop arranged on a small diameter side of the at least one conical configured drive roller and mating roller.

17. The tachograph according to claim 16, wherein the drive device further comprises an electric motor coupled to the drive roller.
